(19) United States
(12) Patent Application Publication
(10) Pub. No.: US 2018/0119473 A1
(43) Pub. Date: May 3, 2018

(54) Non-Invasive Clip-On Doorstopper

(71) Applicant: Todd Jensen, Los Angeles, CA (US)

(72) Inventor: Todd Jensen, Los Angeles, CA (US)

(21) Appl. No.: 15/790,708

(22) Filed: Oct. 23, 2017

(30) Foreign Application Priority Data
Oct. 28, 2016 (ZA) 2016/07446

(51) Int. Cl. E05F 5/08

(52) U.S. Cl. CPC E05F 5/08

(57) ABSTRACT

A non-invasive doorstopper includes first and second arms extending outwardly between a bridging element/base, the bridging element being configured to engage with an edge of a door and the arms being arranged to engage operably with opposite sides of the door. The first arm is resilient and movable against a base to clip onto the side of the door, i.e. to a top or bottom edge. The doorstopper includes a protruding element extending from one of the arms and it extends towards a wall adjacent to a frame to which the door is hingedly connected, the protruding element being configured to engage with the wall ahead of the door for preventing the door from impacting or engaging directly with the wall.

### REFERENCE TO RELATED APPLICATIONS

This application claims the benefit of provisional patent application Republic of South Africa Serial No. 2016/07446 filed Oct. 28, 2016 titled A Non-invasive Clip-On Doorstopper and which is incorporated in its entirety herein by reference.

### BACKGROUND OF THE INVENTION

This invention relates generally to doorstoppers and, more particularly, to a non-invasive doorstopper configured to be clipped onto the top, bottom or side of a door, preferably a door that swings open and closed on hinges.

A doorstop (a.k.a. a doorstopper, door stop, or wedge) is an object or apparatus intended to hold a door open, to prevent a door from opening too far, or to prevent a door from banging into a wall to which the door is hinged. The simplest doorstopper is a heavy object positioned against the door to prevent its further movement or a wedge positioned on the floor not in contact with the door unless and until the door is swung open.

Conventional doorstoppers are mounted to a door with invasive and often damaging fasteners, such as by screws, nails, or adhesives into a surface of a door, baseboard, wall, or floor. Once installed, the stoppers tend to become integral with the surface to which they are installed and are not easily removable from the surface without causing damage to the surface. However, it is desirable to sometimes move a doorstopper, such as when desiring to paint or stain the surface, or simply to remove the doorstopper for use on another door.

Over time the conventional doorstoppers tend to bend, break, and damage the surrounding surfaces that they are affixed to.

Therefore, it would be desirable to have a doorstopper that absorbs or prevents impact of the door or door handle with a wall surface yet attaches to the top or bottom of a door without invasive hardware.

### SUMMARY OF THE INVENTION

A non-invasive doorstopper according to the present invention includes first and second arms extending outwardly between a bridging element/base, the bridging element being configured to engage with an edge of a door and the arms being arranged to engage operably with opposite sides of the door. The first arm is resilient and movable against a base to clip onto the side of the door, i.e. to a top or bottom edge. The doorstopper includes a protruding element extending from one of the arms and it extends towards a wall adjacent to a frame to which the door is hingedly connected, the protruding element being configured to engage with the wall ahead of the door for preventing the door from impacting or engaging directly with the wall.

In a first version, the protruding element may be in the form of a bulge, half sphere or half circle that is either completely fixed to the arm or is fixed on the top of the half sphere, bulge or half circle but not attached or fixed to the arm at the bottom of the sphere, bulge or half circle. By not having the sphere completely fixed, top and bottom, this gives more flexibility and cushion to the clip-on doorstopper when it arrives at the wall or baseboard. This slows the momentum of the door down and will cushion its impact against the wall thereby stopping the door handle from damaging the wall.

In a second version, the protruding element may be rigid and may extend substantially, horizontally outwardly, from one of the arms and can have rounded ends. This slows the momentum of the door down and will cushion its impact against the wall thereby stopping the door handle from damaging the wall.

In a third version, the protruding element may be in the form of a third arm connected to one of the arms, the third arm being flexible and being arranged to move against a bias relative to the arm to which it is connected. This slows the momentum of the door down and will cushion its impact against the wall thereby stopping the door handle 5 from damaging the wall. In this third version, the third arm may be “V-shaped” and may tapper from a base region thereof to an inwardly curved/rounded/curled end.

In a fourth version, the protruding element may be a combination of an elongate shaft extending from the second arm and terminating in a bulging semi-circular member.

In a fifth version, the protruding element may be a combination of an elongate shaft extending from the second arm and terminating within a generally circular cap. A spring may be provided on the shaft for connecting the cap to the second arm. In use the cap being arranged to engage the wall and upon engagement, the cap compressing the spring to absorb the force of impact of the door against the wall in order to reduce the speed by which the door bounces back from the wall.

In an embodiment, with respect to all of the versions defined above, one of the first or second arms may comprise a hooking element, preferably when the doorstopper is mounted at the top edge of the door.

In an embodiment, the bridging element is extendable and may comprise an adjustment means for incrementally adjusting the width of the bridging element to accommodate doors of a larger thickness at their leading edges.

In an embodiment, one of the arms, preferably the arm provided with the hook, may also be extendable and may comprise an adjustment means as described above.

In an embodiment, the doorstopper may be an integrally formed structure constructed (molded, typically) from flexible elastomeric material, plastic material, flexible metallic or any other flexible solid material.

Therefore, a general object of this invention is to provide a non-invasive doorstopper that may be clipped onto the top, bottom or side edge of a hinged door without the use of other hardware.

Another object of this invention is to provide a non-invasive doorstopper, as aforesaid, that is attachable and removable from a door without damaging the door or wall.

Still another object of this invention is to provide a non-invasive doorstopper, as aforesaid, that is inexpensive to manufacture and purchase.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a doorstopper according to one embodiment of the invention;

FIG. 2 is a perspective view of the doorstopper according to another embodiment of the present invention;

FIG. 3 is a perspective view of the doorstopper according to another embodiment of the present invention;

FIG. 4 is a perspective view taken from another angle of the doorstopper as in FIG. 2;

FIG. 5 is a perspective view taken from another angle of the doorstopper as in FIG. 1;

FIG. 6 is a perspective view taken from another angle of the doorstopper as in FIG. 3;

FIG. 7 is a perspective view of a doorstopper with a hooking element according to another embodiment of the present invention;

FIG. 8 is a perspective view of a variation of the doorstopper of FIG. 7;

FIG. 9 is a perspective view of the doorstopper as in FIG. 7 with the protruding element as in FIG. 2;

FIG. 10 is a perspective view from another angle of the doorstopper as in FIG. 7 with the protruding element as in FIG. 9;

FIG. 11 is a perspective view of the doorstopper as in FIG. 7 with the protruding element as in FIG. 3;

FIG. 12 is a perspective view from another angle of the doorstopper as in FIG. 7 with the protruding element as in FIG. 11;

FIG. 13 is a perspective view of a doorstopper according to another embodiment of the present invention having a bridging element length adjusting mechanism and illustrated in one configuration;

FIG. 14 is another perspective view of the doorstopper as in FIG. 13 illustrated in another configuration;

FIG. 15 is an isolated view on an enlarged scale taken from FIG. 14;

FIG. 16 is a perspective view of a doorstopper according to another embodiment of the present invention;

FIG. 17 is a perspective view of a doorstopper according to another embodiment of the present invention having an auxiliary length adjusting mechanism;

FIG. 18 is a perspective view of a doorstopper according to another embodiment of the present invention;

FIG. 19 is a perspective view of a variation of the doorstopper of FIG. 1;

FIG. 20 is a perspective view of the doorstopper as in FIG. 19 taken from an inverted angle;

FIG. 21 is a perspective view of a doorstopper as in FIG. 7 with the protruding element of FIG. 19 along with the bridging element adjustment mechanism of Fig.;

FIG. 22 is a perspective view from another angle of the doorstopper as in FIG. 21;

FIG. 23 is a perspective view of the doorstopper as in FIG. 13 illustrated in one configuration; and

FIG. 24 is a perspective view of the doorstopper as in FIG. 23 illustrated in another configuration.

### DESCRIPTION OF THE PREFERRED EMBODIMENT

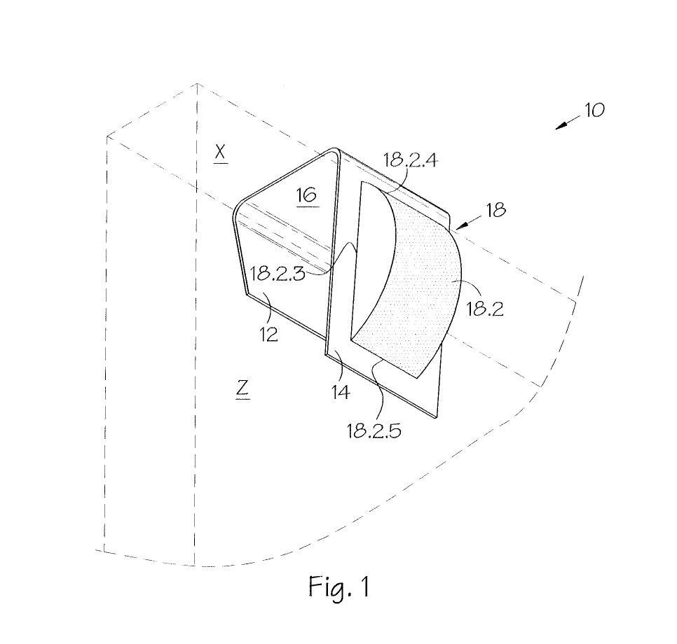

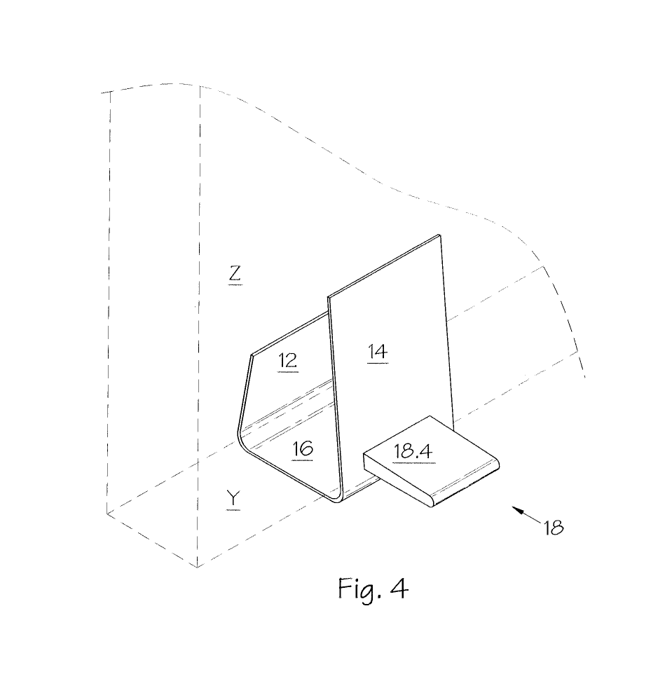

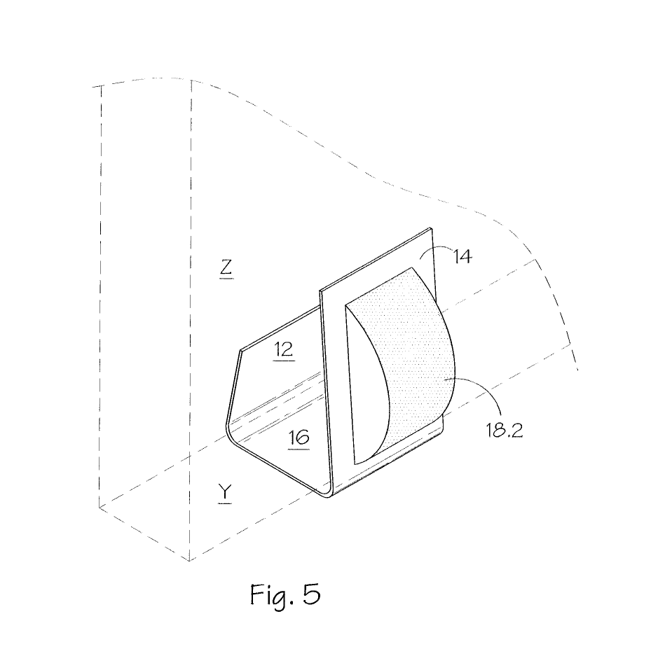

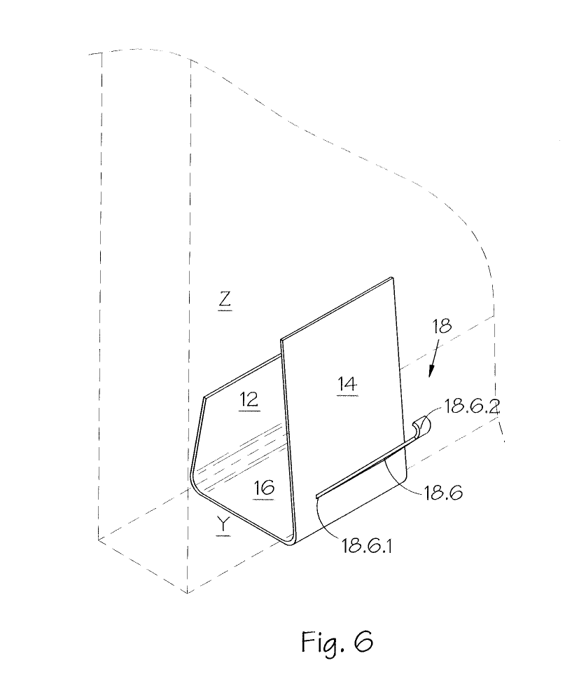

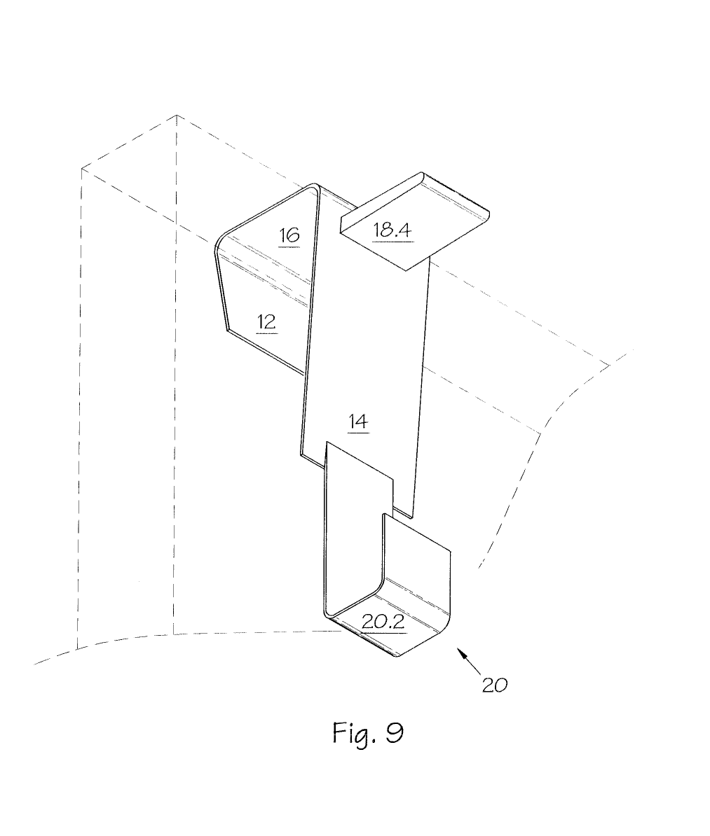

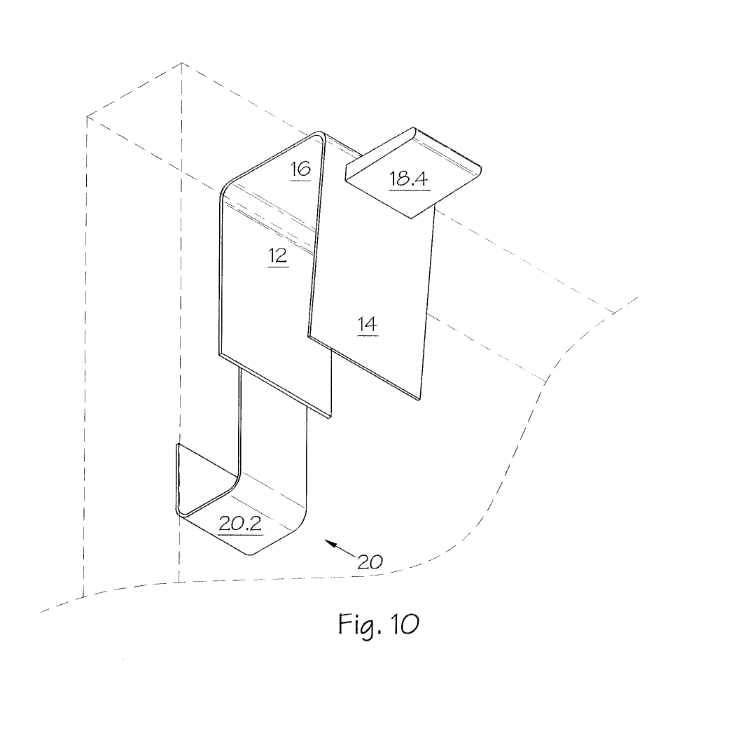

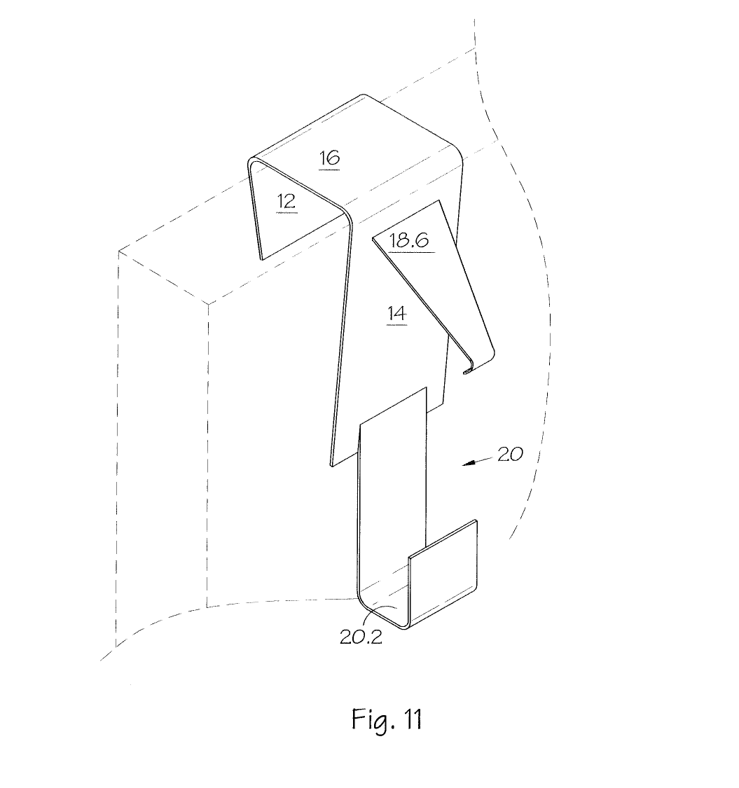

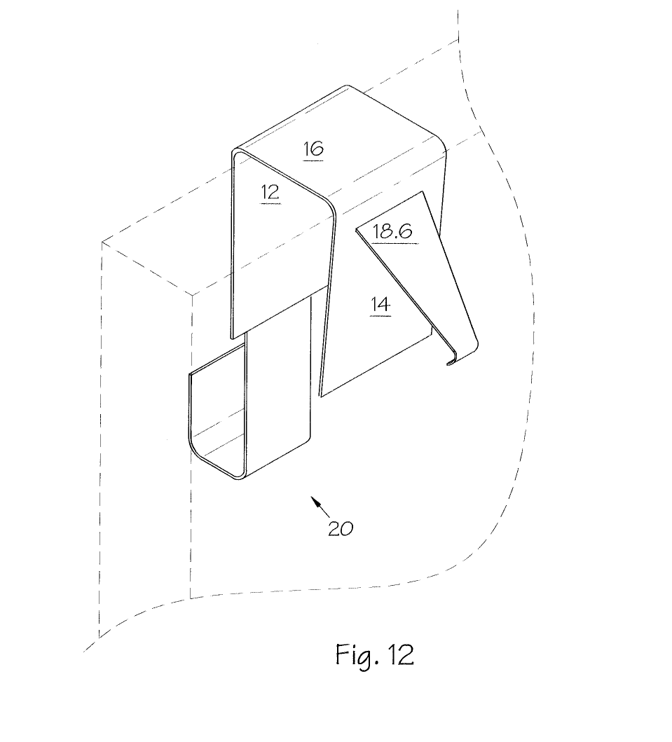

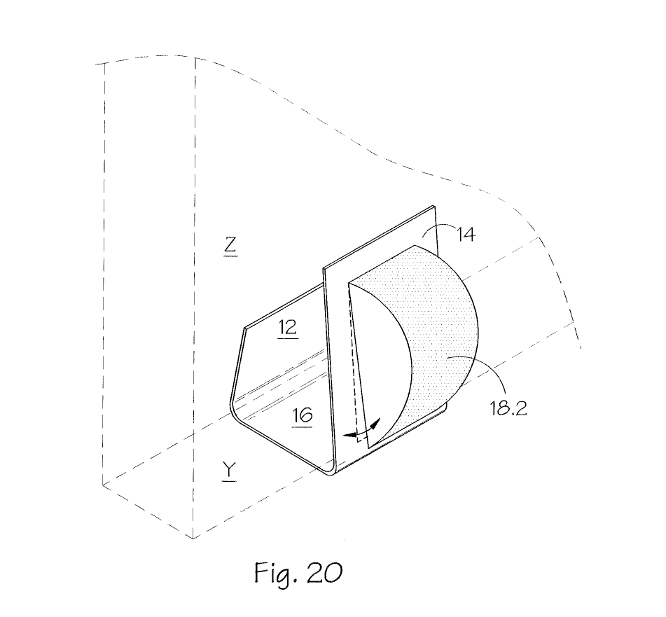

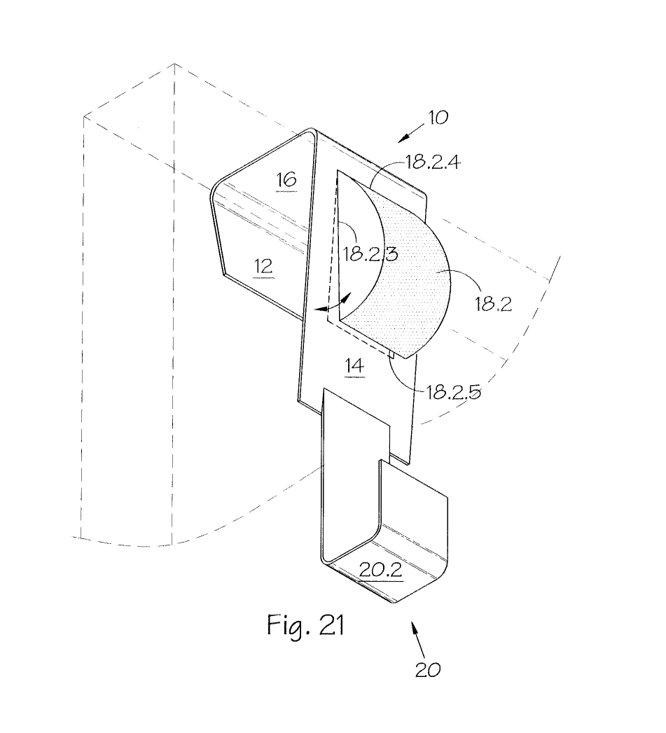

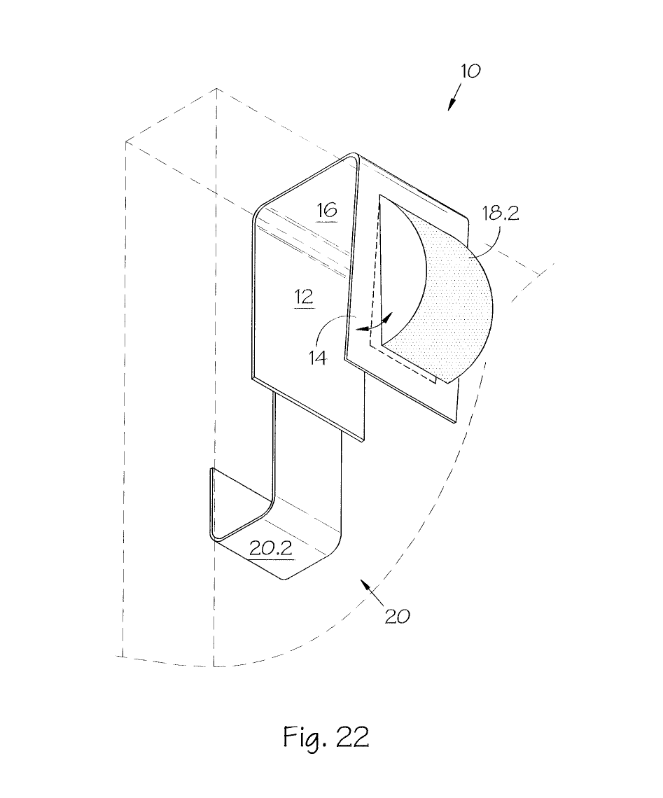

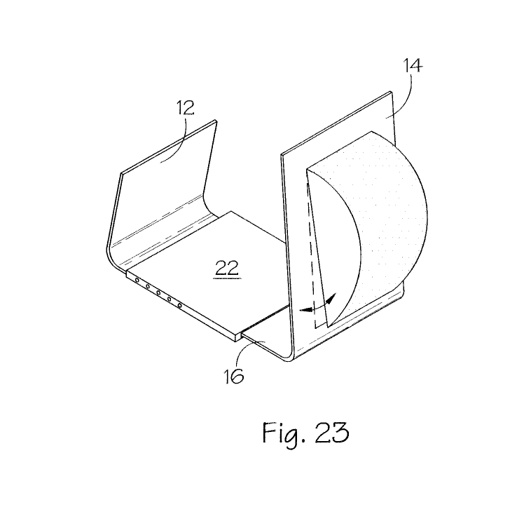

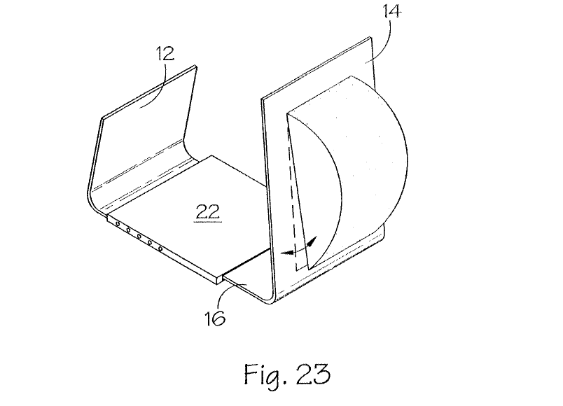

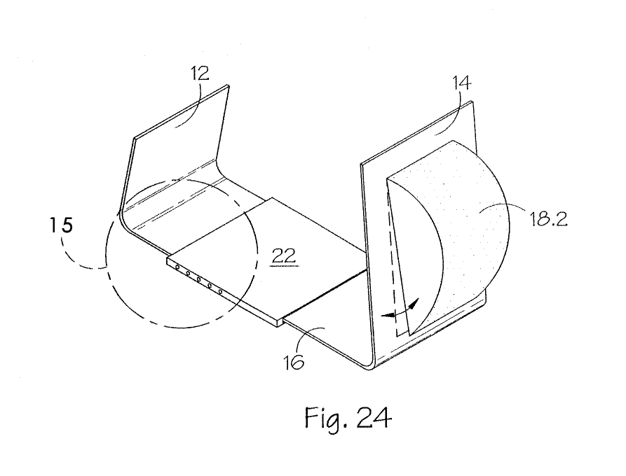

A non-invasive doorstop apparatus according to a preferred embodiment of the present invention will now be described in detail with reference to FIGS. 1 to 24 of the accompanying drawings.

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features.

Accordingly, those skilled in the art will recognize that modifications and adaptations to the present invention are possible and can even be desirable in certain circumstances, and are a part of the present invention. Thus, the following description is provided as illustrative of the principles of the present invention and not a limitation thereof.

As can best be seen in the drawings, there is provided a non-invasive doorstopper designated by reference numeral 10 comprising generally, a pair of first and seconds arms 12, 14 extending outwardly between a bridging element/base 16. The bridging element 16 is shown in FIGS. 1 to 12 as being engaged with either a top edge “x” or bottom edge “y” of a door “z” (shown in dashed lines as being partly sectioned).

As best shown in FIGS. 1 to 23, the first and second arms 12, 14 are arranged to engage operably with opposite sides of the door “z”.

As best shown in the drawings, the non-invasive doorstopper 10 is integrally formed i.e. monolithic/one piece; and the first arm 12 is shown as slanting towards the second arm 14. The first arm 12 of FIGS. 1 to 12 is shown as being flexible and is generally movable against a bias/springiness to clip onto any side of the door, thereby holding/retaining the bridging element 16 and second arm 14 to the door “z”. It is envisaged however, that the second arm 14 may also be movable against a bias to its operable position as shown in the FIGS. 1 to 12.

It will be appreciated that the non-invasive doorstopper 10 may be constructed from polymeric/plastic material, metal based material, or any other solid material that is flexible enough to permit the non-invasive doorstopper 10 to clip selectively onto the top “x”, bottom “y,” or side of a door (not shown). Further, the doorstopper 10 comprises a protruding element 18 extending outwardly away from the second arm 14, i.e. away from an outer surface of the second arm 14. The protruding element 18 faces the wall side (not shown) of the door “z” to which one end of the door “z” is hingedly connected. It is appreciated that the protruding element 18 is dimensioned such that it will always engage with the wall ahead of the door “z” or door handle (not shown) for preventing the door or handle thereof from impacting/engaging directly with the wall.

In a first version, the protruding element 18 may be in the form of a bulge/semicircular protrusion labeled with reference numeral 18.2 extending outwardly from the second arm 14, as best seen in FIGS. 1, 5, 7, 8, 13 and 14. The bulge 18.2 comprises a base 18.2.3 attached to the second arm 14, and comprises first and second opposed ends 18.2.4, 18.2.5 which are also attached to the second arm 14.

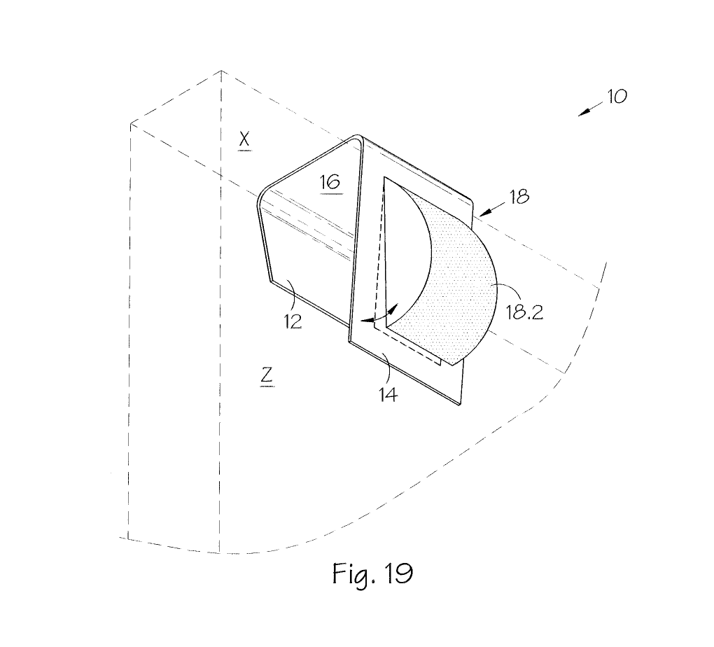

In an alternative version, as best shown in FIGS. 19 to 23, the first end 18.2.4 is attached to the second arm 14 while the second end 18.2.5 is spaced apart from the second arm 14 such that a gap is defined between the base 18.2.3 and the second arm 14. In this alternative version, the bulge 18.2 is arranged, in use, to engage the wall ahead of the second arm 14 and swings inwardly towards the second arm 14 upon impact with the wall. It is envisaged that the amount by which the bulge 18.2 swings back will absorb the force of impact of the door against the wall and thereby decrease the “bounce back” speed of the door from the wall.

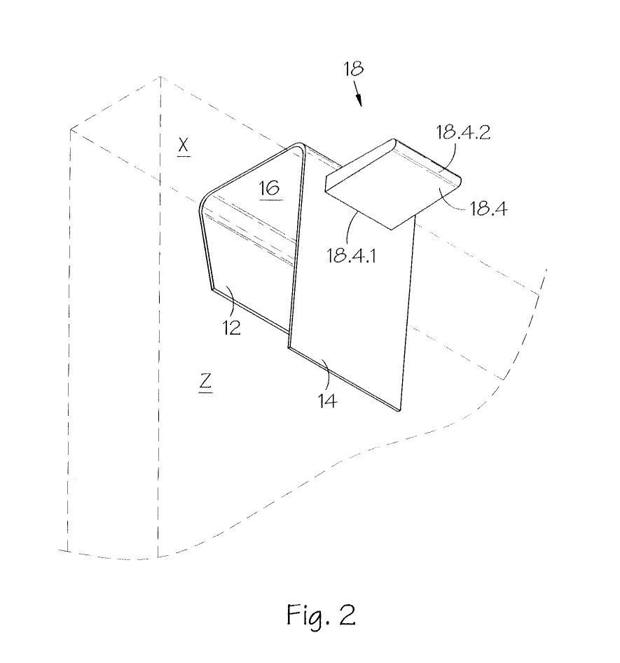

In a second version, as best shown in FIGS. 2, 4, 9, and 10, the protruding element 18 may be a substantially flat plate 18.4 extending outwardly, perpendicular, and away from a base region thereof 18.4.1 toward rounded ends 18.4.2 thereof. The plate 18.4 is substantially horizontal with the ground (not shown) and is long enough to engage with the wall ahead of the door/handle thereof.

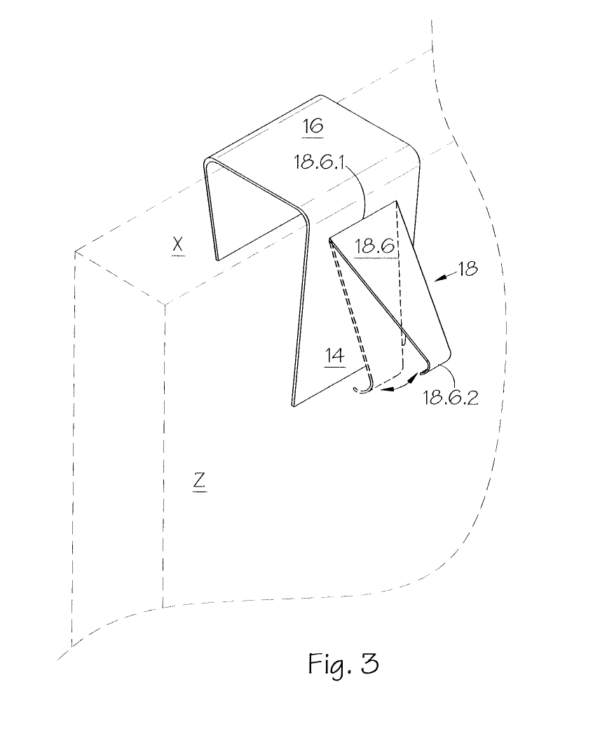

In a third version, as best shown in FIGS. 3, 6, 11 and 12, the protruding element 18 may be in the form of a third flexible, springy, or resilient arm/flap 18.6 connected to the second arm 14. The flap 18.6 has a “V-shaped” configuration and tapers from a base region 30 18.6.1 thereof to a curled end 18.6.2 thereof. The end is preferably curled to prevent the flap 18.6 from damaging the wall. Please note that the doorstopper will always be first to impact a wall and prevent the door handle from damaging the wall.

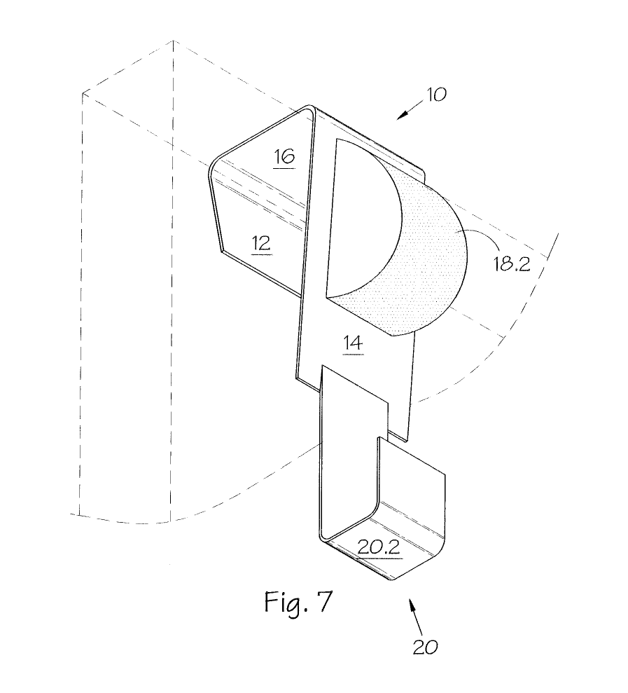

As best shown in FIGS. 7 to 12, the doorstopper 10 comprises a hooking element 20 which may be provided on either of the arms 12, 14 for hanging garments onto the door.

It will be appreciated that the protruding element 18 of all of the versions defined above, is longer than the base of the hook 20.2, i.e. extends further away from the second arm, and is configured to engage the wall first ahead of the base of the hook 20.2.

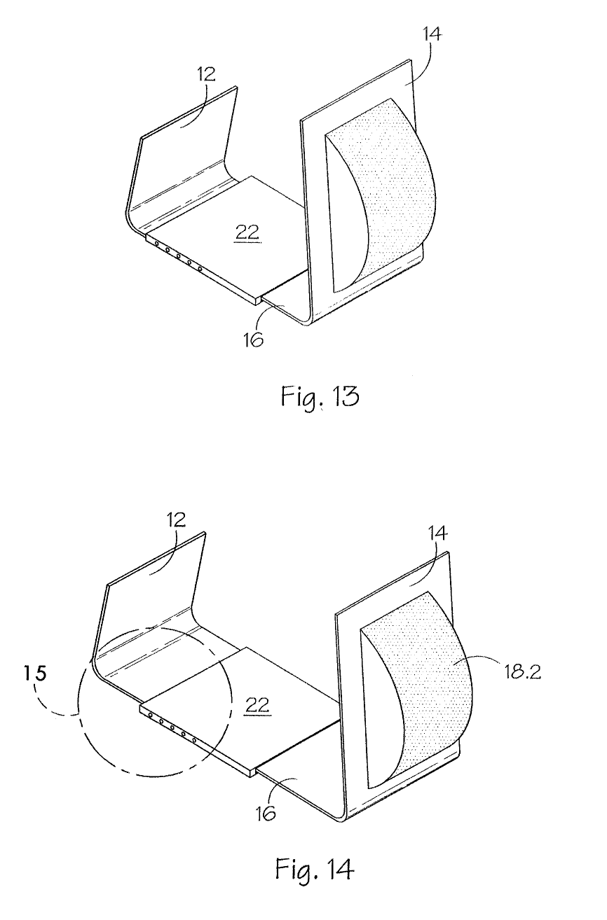

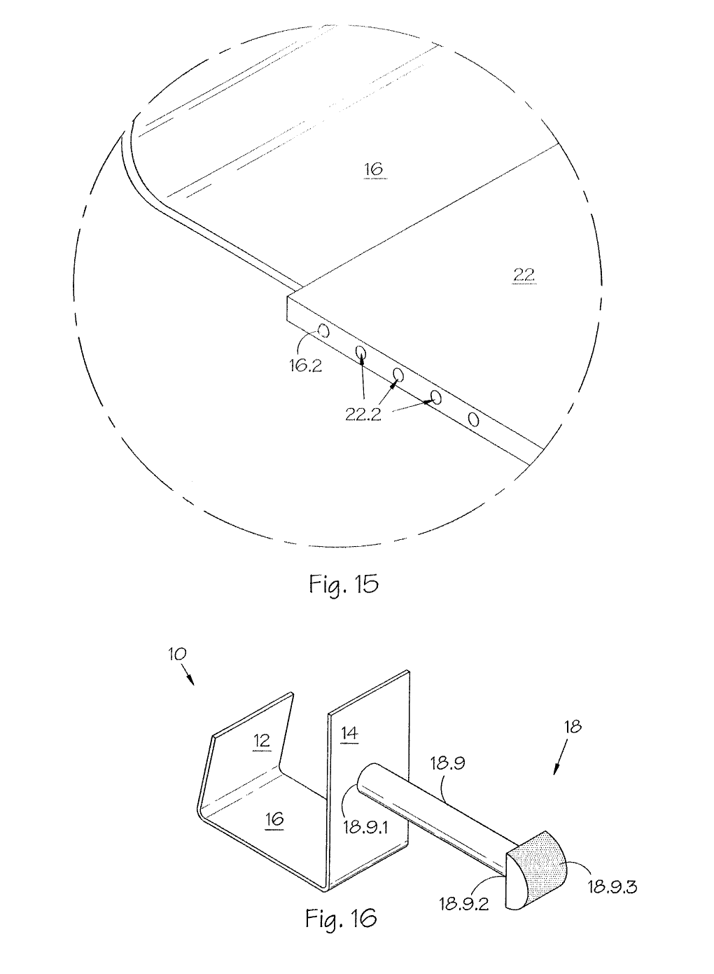

As best shown in FIGS. 13 to 15, the bridging element 16 may comprise a first part (also referred to as a first section) arranged to overlay and move slidably relative to a second part (also referred to as a second section); both first and second parts being accommodated within a housing 22. The housing 22 defines a plurality of openings 22.2 at an end face thereof 22.4 arranged to receive an actuable locking pin 16.2 extending outwardly from an end face of the bridging element 16. The locking pin 16.2 is releasably and engaged with one of the openings 22.2 as the first part slides relative to the second part. As best shown in FIG. 13, the bridging element 16 is shown in the retracted position, and FIG. 14 shows the bridging element 16 being extended/widened with the locking pin 18.2 extending from the last opening provided in the housing 22, as shown in FIG. 15. Extension of the bridging element 16 permits the non-invasive doorstopper 10 to be used on doors of various widths. The standard width of a door for internal domestic use is approximately 42 mm.

In a fourth version, as best shown in FIG. 16, the protruding element 18 may be a combination of an elongate shaft 18.9 extending from the second arm 14 at an end region 18.9.1 thereof toward a flat end face 18.9.2 defined by a base 18.9.2 of a bulging semi-circular member 18.9.3. As can best be seen in this drawing, the shaft 18.9 is configured to permit the bulge 18.9.3 to engage the wall way ahead of the second arm 14.

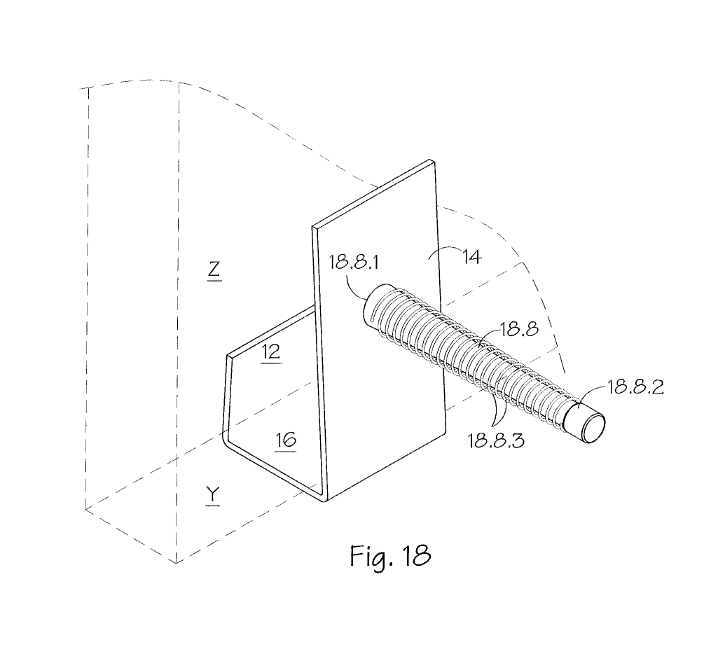

In a fifth version, as best shown in FIG. 18, the protruding element 18 may be an elongate shaft 18.8 extending from the second arm 14 at an end region 18.8.1 thereof and terminating within a generally circular cap 18.8.2 provided separately. A spring 18.8.3, also provided separately, is provided on the shaft 18.8 and connects to the cap 18.8.2 to the second arm 14. In use the cap 18.8.2 is arranged to engage the wall and upon engagement, the cap 18.8.2 being configured to compress the spring 18.8.3 so as to absorb the force of impact of the door against the wall in order to reduce the speed by which the door bounces back from the wall.

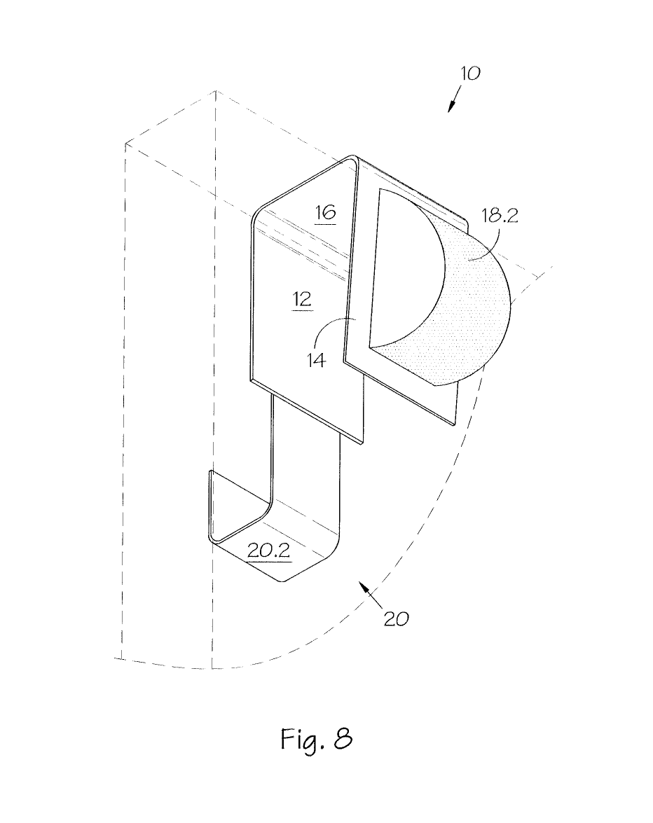

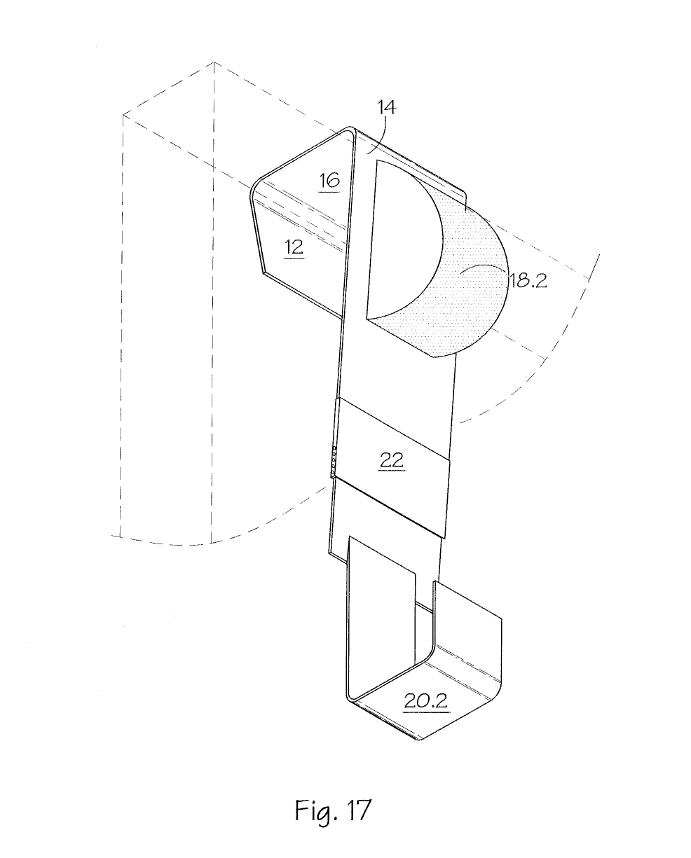

In a sixth version, as best shown in FIG. 17, the extension mechanism 22 (described above) used on the base 16 of FIGS. 13 to 15, is used for extending the second arm 14 on which the hook is attached. The same mechanism can be used on the first arm 12 of FIGS. 8, 10, and 12.

In use, the non-invasive doorstopper 10 may be fitted to the top edge “x”, bottom edge “y,” or side edge (not shown) of the door “z” by flexing out the first arm 12 away from the second arm 14, or flexing out anyone of the arms 12, 14, to permit the doorstopper 10 to be slidably engaged with the door “z”; i.e. to permit the edge of the door to be received in a “U-shaped” channel defined between the arms 12, 14 and bridging element 16. Once the bridging element 16 is held in engagement with the door edge “x” or “y,” and the second arm 14 is engaged with the side of the door “z,” the first flexed out arm 12 is released by a user and the first arm 12 moves under its bias to clip onto the other side of the door “z” thereby fixing the bridging element 16 and second arm 14 to the door.

When the door “z” is slammed in the direction of the wall, the protruding element 18 acts as a buffer/bumper and engages with the wall ahead of the door or handle of the door to prevent the door from being slammed against the wall. The resilient properties of the protruding element 18 allows the non-invasive doorstopper 10 to spring the door back from the wall.

When the user wishes to use the non-invasive doorstopper 10 on another door somewhere in the house or office, the user can simply slide the doorstopper 10 off the one door and carry it effortlessly in the house or office for clipping onto another door; alternatively, the user can simply remove the non-invasive doorstopper 10 from the door, and stow the doorstopper 10 in a safe place for future use.

It is understood that while certain forms of this invention have been illustrated and described, it is not limited thereto except insofar as such limitations are included in the following claims and allowable functional equivalents thereof.

1. A non-invasive doorstopper for attachment to a door having front and rear sides connected by a top edge and a bottom edge, comprising:
a first arm;
a second arm displaced from said first arm;
a bridging element connecting said first arm to said second arm;
wherein said first arm, said second arm, and said bridging element are collectively configured for attachment to one of a top edge or a bottom edge of the door;
a protruding element coupled to an outer side of said second arm and extending away therefrom;
wherein said first arm includes a distal end displaced from said bridging element and inwardly biased toward said second arm to facilitate a secure fit to the door.

2. The non-invasive doorstopper as in claim 1, wherein said first arm, said second arm, and said connecting member define a U-shaped configuration that selectively sandwiches the top edge or bottom edge of the door.

3. The non-invasive doorstopper as in claim 1, wherein:
said protruding member includes an outwardly extending semi-circular shape configuration,
said protruding member includes a first end proximate the bridging element and a second end displaced from said bridging element.

4. The non-invasive doorstopper as in claim 3, wherein said first end of said protruding member is attached to the second arm and the second end of said protruding member is unattached to said second arm and defining a gap therebetween for selectively absorbing a impact force.

5. The non-invasive doorstopper as in claim 1, wherein said protruding element is a plate that extends away from and perpendicular to said second arm, said plate having a rounded outer edge.

6. The non-invasive doorstopper as in claim 1, wherein said protruding element is a spring flap having a proximal end coupled to the second arm proximate said bridging element and a distal end displaced from said second arm, said spring flap defining a V-shaped configuration and being tapered from said proximal end to said distal end and said distal end having a curled configuration extending toward said second arm.

7. The non-invasive doorstopper as in claim 1, further comprising a hooking element coupled to one of said first and said second arm, said hooking element defining a U-shaped configuration that is inverted from a U-shaped configuration defined by said first arm, said second arm, and said bridging element.

8. The non-invasive doorstopper as in claim 7, wherein said hooking element includes:
an inner arm coupled to said second arm and extending away;
an outer arm displaced from said inner arm;
an auxiliary bridge connecting said inner arm and said outer arm.

9. The non-invasive doorstopper as in claim 8, wherein said protrusion is displaced farther from said second arm than said outer arm is displaced from said outer arm of said hook element, whereby said protrusion is first to bear against a wall adjacent the door.

10. The non-invasive doorstopper as in claim 7, wherein:
said protruding member includes an outwardly extending semi-circular shape configuration,
said protruding member includes a first end proximate the bridging element and a second end displaced from said bridging element.

11. The non-invasive doorstopper as in claim 10, wherein said first end of said protruding member is attached to the second arm and the second end of said protruding member is unattached to said second arm and defining a gap therebetween for selectively absorbing a impact force.

12. The non-invasive doorstopper as in claim 7, wherein said protruding element is a plate that extends away from and perpendicular to said second arm, said plate having a rounded outer edge.

13. The non-invasive doorstopper as in claim 7, wherein said protruding element is a spring flap having a proximal end coupled to the second arm proximate said bridging element and a distal end displaced from said second arm, said spring flap defining a V-shaped configuration and being tapered from said proximal end to said distal end and said distal end having a curled configuration extending toward said second arm.

14. The non-invasive doorstopper as in claim 1, further comprising:
an extension member having at least a pair of opposed side walls, a top wall, and a bottom wall that collectively define an interior area and opposed inlet channels allowing access into said interior area;
wherein said bridging element includes a first section connected to said first arm and a second section connected to the second arm, said first and second sections being selectively received into said interior area of said extension member via respective inlet channels so as to determine a length of said bridging element.

15. The non-invasive doorstopper as in claim 14, wherein:
at least one of said opposed side walls of said extension member defines a plurality of spaced apart openings;
said first section of said bridging member includes a pin extending outwardly laterally;
said pin is selectively received into one of said plurality of spaced apart openings when said first section is received into said interior area so as to adjust a length of said bridging member and a length of displacement between said first arm and said second arm.

16. The non-invasive doorstopper as in claim 1, wherein said protruding element includes a shaft having an elongate configuration extending away from said second arm and includes an end member having a semi-circular configuration.

17. The non-invasive doorstopper as in claim 7, further comprising:
an auxiliary extension member having at least a pair of opposed side walls, a top wall, and a bottom wall that collectively define an interior area and opposed inlet channels allowing access into said interior area;
wherein said second wall includes a first section connected to said bridging element and a second section connected to said outer arm of said hooking element, said first and second sections being selectively received into said interior area of said auxiliary extension member via respective inlet channels so as to determine a length of said second arm.

18. The non-invasive doorstopper as in claim 17, wherein:
at least one of said opposed side walls of said auxiliary extension member defines a plurality of spaced apart openings;
said first section of said second arm includes a pin extending outwardly laterally;
said pin is selectively received into one of said plurality of spaced apart openings when said first section is received into said interior area so as to adjust a length of said second and a length of displacement between said bridging element and said second section of said second arm.

19. The non-invasive doorstopper as in claim 1, wherein said protruding element includes a shaft having an elongate configuration extending away from said second arm and includes a cap situated at a free end thereof, said protruding element including a spring surrounding said shaft.

20. The non-invasive doorstopper as in claim 19, wherein said cap is configured to incrementally compress said spring upon impact with an object for absorbing the impact thereof.
